(19) United States
(12) Patent Application Publication
(10) Pub. No.: US 2022/0200516 A1
(43) Pub. Date: Jun. 23, 2022

(54) SOLAR ENERGY UTILIZATION APPARATUS FOR INSTALLATION ON A ROAD

(71) Applicant: Huiyi Lou, Yiwu (CN)

(72) Inventor: Huiyi Lou, Yiwu (CN)

(21) Appl. No.: 17/490,243

(22) Filed: Sep. 30, 2021

(30) Foreign Application Priority Data
Dec. 18, 2020 (CN) 202011513884.2

(51) Int. Cl. H02S 20/21; H02J 50/00; H02J 7/35; F24S 25/33; B60L 53/30; B60L 8/00; B60L 53/12

(52) U.S. Cl. CPC H02S 20/21; H02J 50/00; H02J 7/35; B60L 53/12; B60L 53/30; B60L 8/006; F24S 25/33

(57) ABSTRACT

A solar energy utilization apparatus for installation on a road includes a mounting frame and solar cells. The mounting frame includes a top support and two lateral mounting legs connected to both sides of the top support, the top support is configured to face the road, and the lateral mounting legs respectively are installed on both sides of the road. The solar cells are arranged on the top support, each of the solar cells has a light receiving surface that is tilted downward, toward a same side of the road at a substantially same angle thereby facing an orientation where sunlight intensity is greater. The invention does not occupy farmland and other green vegetation areas. More importantly, such a configuration can provide a huge installation site for solar energy utilization apparatus, which meets the rapid development of the solar energy industry in the future.

### FIELD OF THE INVENTION

The invention relates to the field of solar energy utilization, in particular to a solar energy utilization apparatus for installation on a road.

### BACKGROUND OF THE INVENTION

The vigorous development of solar energy is bound to involve the issue of installation sites for solar energy apparatus. However, there is no doubt that some sites are unsuitable for installation of the solar energy apparatus, such as farmland, woodland and grassland due to the need for photosynthesis. Desert is a huge installation site, however, solar energy apparatus installed in the desert will be easily covered by sand and dust to have a risk of losing its power generation effect. Moreover, in China for example, it is obviously unrealistic to change the use of farmland into the installation site for solar energy apparatus due to the national policy, and it's also a long-term national planning to increase forest coverage.

By this token, there is a current urgent need to solve the major problem of unsuitable and insufficient installation sites.

### SUMMARY OF THE INVENTION

One objective of the present invention is to provide a solar energy utilization apparatus for installation on a road, which can increase the utilization rate of sunlight and increase the efficiency of power generation.

To achieve the above-mentioned objective, the present invention provides a solar energy utilization apparatus for installation on a road including a mounting frame and solar cells. The mounting frame includes a top support and two lateral mounting legs connected to both sides of the top support, the top support is configured to face the road, and the lateral mounting legs respectively are installed on both sides of the road. The solar cells are arranged on the top support, each of the solar cells has a light receiving surface that is tilted downward, toward a same side of the road at a substantially same angle thereby facing an orientation where sunlight intensity is greater.

Preferably, the solar cells are also installed on that side of the mounting frame where the sunlight intensity is greater, and the solar cells located at the top support and those located at the side of the mounting frame are arranged in an L shape.

Preferably, slits are formed between the top support and that side of the mounting frame where the solar cells are installed, whereby allowing sunlight and wind to pass through.

Preferably, the lateral mounting legs on the sides of the top support have different heights, whereby making the solar cells on the top support to be tilted.

Preferably, a middle mounting leg is connected at a middle of the top support and configured to install on a middle position of the road.

Preferably, the apparatus further includes a transmission module and a wireless charging module, the transmission module is configured to transmit electric energy in the solar cells to the wireless charging module, and the wireless charging module is configured to wirelessly charge vehicles on the road.

Preferably, the wireless charging module is arranged on the top support.

Preferably, the wireless charging module is arranged on the road.

Preferably, the apparatus further includes a transmission module and a charging pile, the transmission module is configured to transmit electric energy in the solar cells to the charging pile, and the charging pile is configured to charge vehicles.

Preferably, the apparatus further includes an auxiliary mounting frame installed on a roadbed slope side where the sunlight intensity is greater, and the solar cells are also installed on the auxiliary mounting frame.

Preferably, the solar cells are arranged into a solar cell array, each of the solar cells is supported by a respective rotatable supporting frame.

In comparison with the prior art, the solar energy utilization apparatus can be installed on roads such as ordinary roads, expressways, ordinary railways, high-speed railways, etc., which utilizes the upper space of the roads to solve the installation problem. No farmland or other green vegetation areas are occupied, no risk of losing power generation effect resulted by the sand and dust covering is generated, and more importantly, such a configuration can provide a huge installation site for solar energy utilization apparatus, which meets the rapid development of the solar energy industry in the future. In addition, the solar cells on the top support of the solar energy utilization apparatus of the present invention all face the orientation where the sunlight intensity is greater, which avoids the situation that some solar cells face the orientation where the sunlight intensity is smaller, so that each solar cells can make full use of sunlight, thereby increasing the utilization rate of sunlight for the solar energy utilization apparatus of the present invention and improving the power generation efficiency.

### BRIEF DESCRIPTION OF THE DRAWINGS

FIG. 1 is a schematic structural diagram of a solar energy utilization apparatus for installation on a road extended from the east to the west according to an embodiment of the present invention;

FIG. 2 is a schematic structural diagram of a solar energy utilization apparatus for installation on a road extended from the northwest to the southeast according to an embodiment of the present invention;

FIG. 3 is a schematic structural diagram of a solar energy utilization apparatus for installation on a road extended from the northeast to the southwest according to an embodiment of the present invention;

FIG. 4 is a schematic block diagram showing power transmission according to an embodiment of the present invention;

FIG. 5 is another schematic block diagram showing power transmission according to another embodiment of the present invention;

FIG. 6 is a schematic structural diagram of a solar energy utilization apparatus installed on a road extended from the east to the west and the outer side of the roadbed slope side respectively;

FIG. 7 is a schematic structural diagram of a solar energy utilization apparatus installed on a road extended from the northwest to the southeast and the outer side of the roadbed slope side respectively;

FIG. 8 is a schematic structural diagram of a solar energy utilization apparatus installed on a road extended from the northwest to the southwest and the outer side of the roadbed slope side respectively;

FIG. 9 is a schematic structural diagram of solar energy utilization apparatus with several slits formed between the top support and the side of the mounting frame where the solar cells are installed, according to an embodiment of the present invention; and

FIG. 10 is a schematic structural diagram of a solar energy utilization apparatus according to another embodiment of the present invention.

### DETAILED DESCRIPTION OF ILLUSTRATED EMBODIMENTS

In order to describe the technical solution and structural features of the present invention in detail, the following description will be made in conjunction with the embodiments and the accompanying drawings.

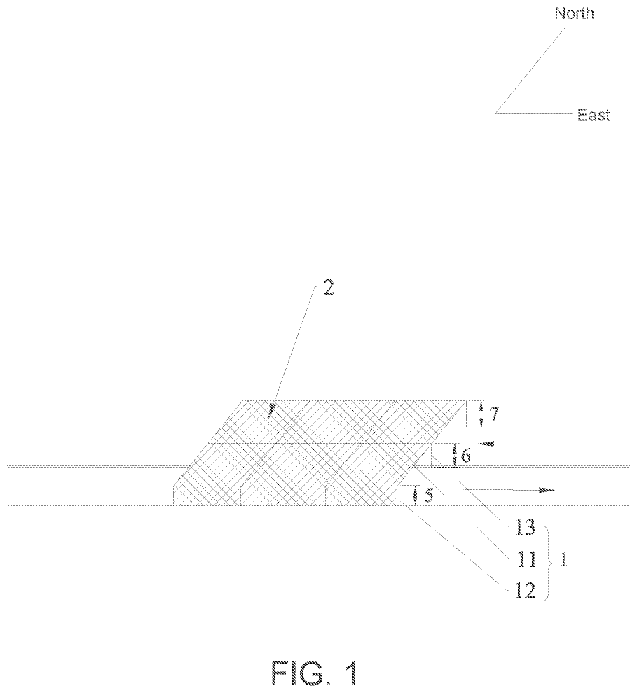

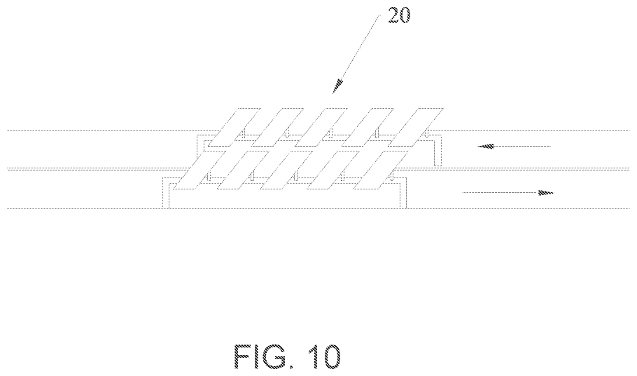

Referring to FIGS. 1 to 5, the present invention provides a solar energy utilization apparatus for installation on roads (such as ordinary roads, expressways, ordinary railways, high-speed railways, etc.), including a mounting frame 1 and solar cells 2. Specifically, the mounting frame 1 includes a top support 11 and two lateral mounting legs 12 connected to both sides of the top support 11, the top support 11 is configured to face the road, and the lateral mounting legs 12 respectively are installed on both sides of the road. The solar cells 2 are arranged on the top support 11, each of the solar cells 2 has a light receiving surface that is tilted downward, toward a same side of the road at a substantially same angle thereby facing an orientation where the sunlight intensity is greater. It should be noted that the “road” in the present invention may be a highway, a railway, etc., which is not limited here. The “both sides of the road” may be both sides of a two-way lane, or both sides of a one-way lane. When there is a transitional section such as a green belt in the middle of the two-way lane, one of the sides may be the side having the transitional section. It should be noted that the “solar cells” referred to herein can be an integral solar panel composed of a plurality of solar cells, or a solar cell array including a plurality of independent solar cells arranged in a specific form. FIGS. 1-9 show a whole large solar panel, while FIG. 10 shows an array composed of multiple independent solar cells.

The solar cells 2 on the top support 11 of the solar energy utilization apparatus of the present invention are all tilted to the orientation where the sunlight intensity is greater, which avoids the situation that some solar cells 2 face the orientation where the sunlight intensity is smaller (for example, when the top support 11 is a “herringbone” structure), so that each solar cells 2 can make full use of sunlight, thereby increasing the utilization rate of sunlight for the solar energy utilization apparatus of the present invention and improving the power generation efficiency.

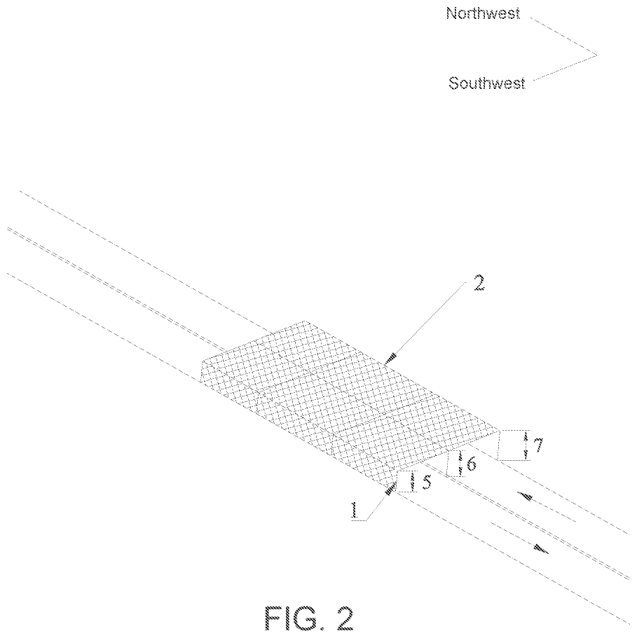

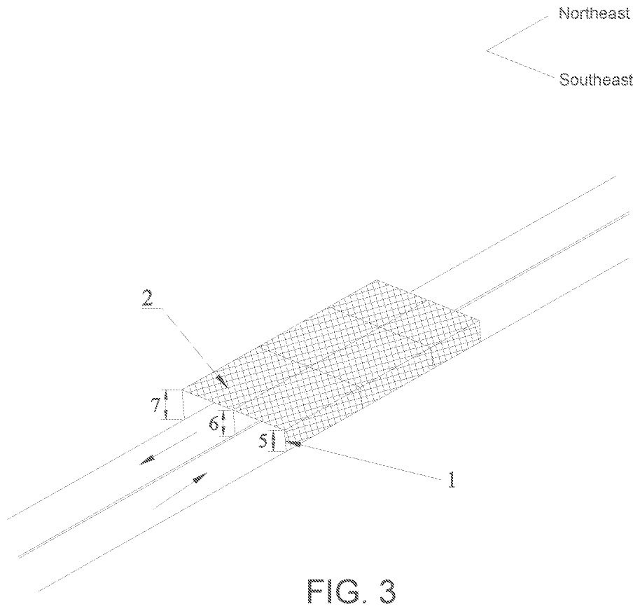

Taking the northern hemisphere as an example, the orientation with the greatest sunlight intensity is the south. As shown in FIG. 3, when the road is extended in the direction from the northeast to the southwest, the solar cells 2 may be tilted towards the southeast to more fully receive sunlight. As shown in FIG. 2, when the road is extended in the direction from the northwest to the southeast, the solar cells 2 may be tilted towards the southwest. As shown in FIG. 1, when the road is extended in the direction from the east to the west, the solar cells 2 may be tilted towards the south. Roads with other extending orientations will not be explained one by one.

In some embodiments, a side of the mounting frame 1 where the sunlight intensity is greater is also provided with solar cells 2, and the solar cells 2 on the top support 11 and the solar cells 2 on the side of the mounting frame 1 are arranged in an L shape. In such an arrangement, the area that receives sunlight can be effectively increased, and the L-shaped installation and arrangement of solar cells will not affect the daylighting of the road.

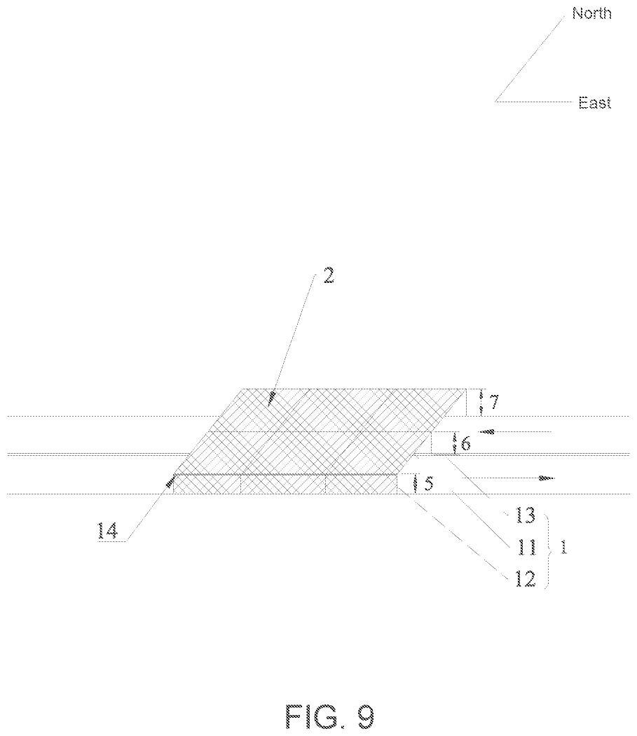

Referring to FIG. 9, in some embodiments, several slits 14 are formed between the top support 11 and the side of the mounting frame 1 where the solar cells 2 are installed, thereby allowing sunlight and wind to pass through. Specifically, the opening width of the slits 14 are set to about 50 cm. In such an arrangement, not only the influence of wind pressure can be reduced, but also the daylighting effect of the road can be further ensured.

In some embodiments, the lateral mounting legs 12 on the sides of the top support 1 have different heights so as to make the solar cells 2 on the top support 11 to be tilted. The installation of the lateral mounting legs 12 with different heights facilitates the tilted arrangement of the solar cells 2 on the mounting frame 1, and further facilitates the solar cells 2 to tilt toward the orientation where the sunlight intensity is greater, so that the solar cells 2 can fully receive the sunlight.

In some embodiments, a middle mounting leg 13 is connected at the middle position of the top support 11 and configured to install on the middle position of the road, such as a green belt. Specifically, the heights of the mounting legs 12 and 13 decrease toward the direction where the sunlight intensity is greater. For example, their heights can be set to 7 meters, 6 meters and 5 meters respectively. In such a way, when the solar energy utilization apparatus of the present invention is installed on a two-way multi-lane, it is beneficial to enhance the stability of the overall structure.

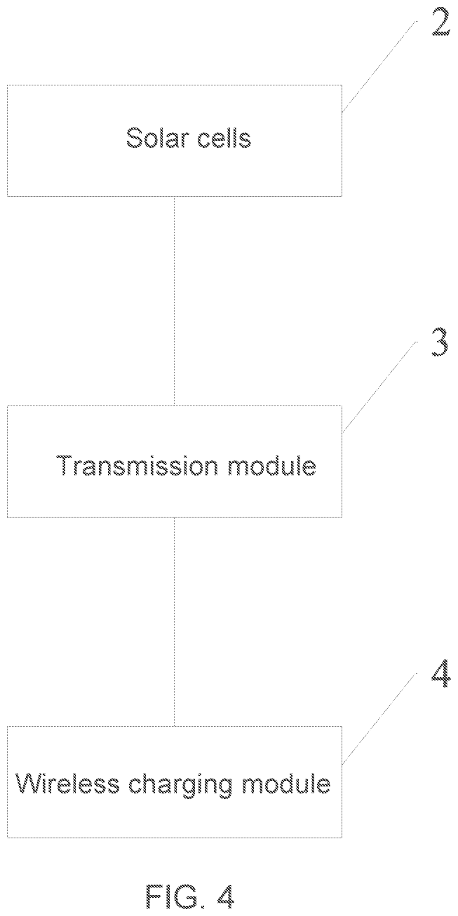

Referring to FIG. 4, in some embodiments, the solar energy utilization apparatus further includes a transmission module 3 and a wireless charging module 4. The transmission module 3 is configured to transmit the electric energy in the solar cells 2 to the wireless charging module 4, and the wireless charging module 4 is configured to wirelessly charge vehicles on the road. In such a way, the solar energy utilization apparatus of the present invention may simultaneously charge multiple vehicles running on the road, so that it's unnecessary for the user to seek a special charging place for charging, thereby improving the user experience.

As an optional embodiment, the wireless charging module 4 may be arranged on the top support 11.

As an optional embodiment, the wireless charging module 4 may be installed on the road.

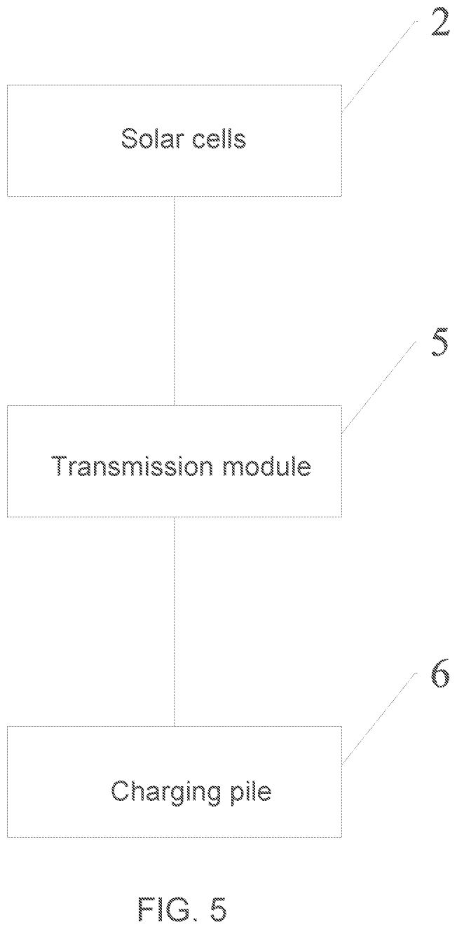

Referring to FIG. 5, in some embodiments, the solar energy utilization apparatus further includes a transmission module 5 and a charging pile 6. The transmission module 5 is configured to transmit the electric energy in the solar cells 2 to the charging pile 6, and the charging pile 6 is configured to charge the vehicles. By using the transmission module 5 to transmit the electric energy of the solar cells 2 to the charging pile 6, the solar energy can be utilized more fully. Specifically, the charging pile 6 may be installed in a charging station which may be located near the road or far away from the road, which is not limited, thereby bringing convenience to the users.

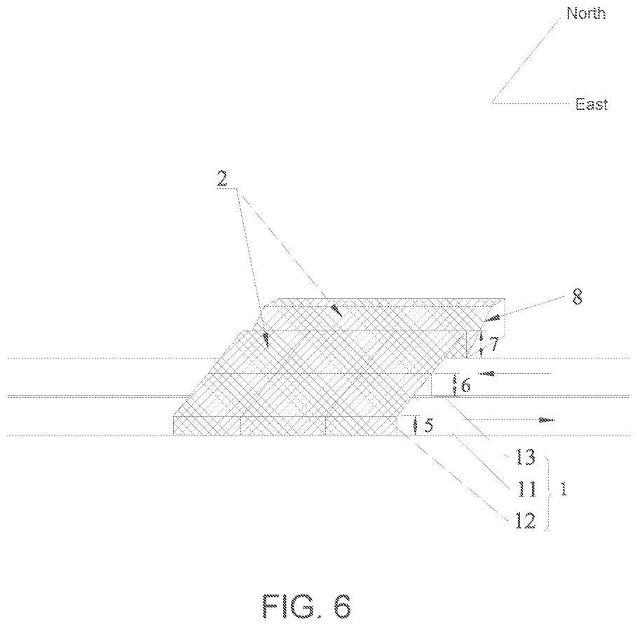

Referring to FIGS. 6 to 8. In some embodiments, the solar energy utilization apparatus further includes an auxiliary mounting frame 8 which is installed on a roadbed slope side where the sunlight intensity is greater, and the auxiliary mounting frame 8 is also installed with the solar cells 2.

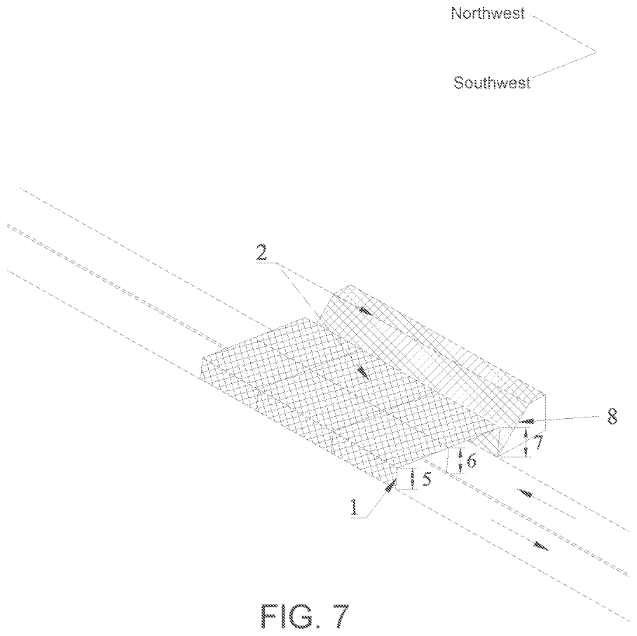

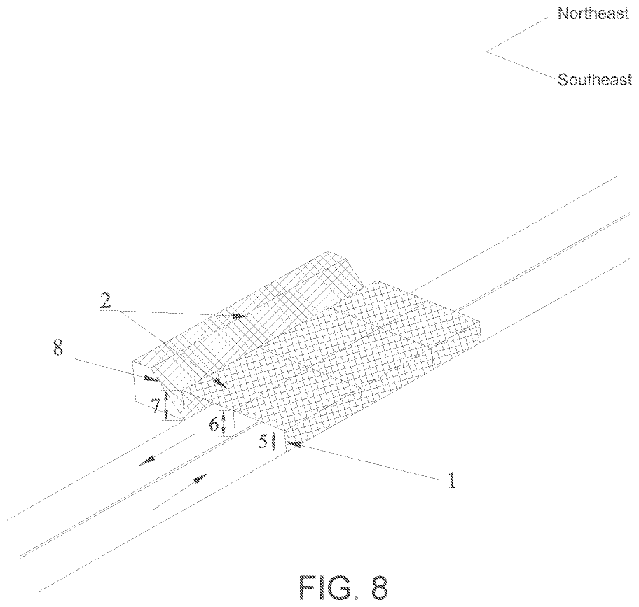

Specifically, taking the northern hemisphere as an example, the orientation with the greatest sunlight intensity is the south. As shown in FIG. 8, when the road is extended in the direction from the northeast to the southwest, the auxiliary mounting frame 8 providing with solar cells 2 are installed on the roadbed slope side facing to the southeast, so as to more fully receive sunlight. As shown in FIG. 7, when the road is extended in the direction from the northwest to the southeast, the auxiliary mounting frame 8 providing with solar cells 2 are installed on the roadbed slope side facing to the southwest. As shown in FIG. 6, when the road is extended in the direction from the east to the west, the auxiliary mounting frame 8 providing with solar cells 2 are installed on the roadbed slope side facing to the south. Roads with other extending directions will not be explained one by one.

The solar cells in the above-mentioned embodiments are in a form of large-scale solar panel, while in other embodiments, a solar cell array 20 may be used, as shown in FIG. 10. The solar cell array 20 is composed of multiple small solar cells. Each solar cell is supported by an independent rotatable supporting frame, and is controlled to adjust its own tilted angle through the rotatable supporting frame by a control system, with changes in sunlight intensity, sunlight incident angle, etc., to follow and chase the sunlight.

By the above technical means, it is possible to make full use of the area around the road suitable for installing solar energy utilization apparatus, increase the installation area of the solar energy utilization apparatus, and further make full use of sunlight.

The solar energy utilization apparatus of the present invention can be connected to the national grid by a transmission device, to wider and broaden the utilization of the electricity generated obtained from the solar energy utilization apparatus, which is beneficial to accelerate the replacement of fossil energy by clean energy, and provides strong support for the realization of the carbon neutrality goal of various countries. Moreover, by connecting the solar energy utilization apparatus of the present invention to the national grid, it is also conducive to reducing the overall electricity cost of the society.

When the solar energy utilization apparatus is installed above the roads or above the high-speed rail racks, environment-friendly energy can be fully utilized, without affecting the photosynthesis of plants, thus the demand for thermal power, oil and coal resources will be greatly reduced to effectively protect the environment. Moreover, compared to the status that the apparatus is installed in the desert, the solar energy utilization apparatus of the present invention is not easily covered by sand and dust to avoid the risk of losing power generation effect. At the same time, solar energy as a clean energy becomes a research interest of national strategy and future development, with the continuous maturity of technology, the cost of the solar energy is reduced year by year, which is conducive to reducing the cost of power generation.

Take installation on railways as an example, at present, the total railway mileage in China is about 150,000 kilometers. Based on a width of about 25 meters, if all the railways are installed with solar energy utilization apparatus, approximately 1.1 trillion kilowatt-hours of electricity can be generated per year, which is equivalent to the power generation capacity of 10 times of Three Gorges in China. As for highways, highways in China are about 5 million kilometers, based on a width of about 25 meters, approximately 3.5 trillion kilowatt-hours of electricity can be generated per year, even if one-tenth of the highways are equipped with solar energy utilization apparatus. However, total annual electricity consumption in China is only 7 trillion kilowatt-hours. By this token, the large-scale use of the solar energy utilization apparatus of the present invention has great significance in terms of economic, social, environmental protection and other aspects.

While the invention has been described in connection with what are presently considered to be the most practical and preferred embodiments, it is to be understood that the invention is not to be limited to the disclosed embodiments, but on the contrary, is intended to cover various modifications and equivalent arrangements included within the spirit and scope of the invention.

What is claimed is:

1. A solar energy utilization apparatus for installation on a road, comprising:
a mounting frame, comprising a top support and two lateral mounting legs connected to both sides of the top support, the top support being configured to face the road, and the lateral mounting legs respectively being installed on both sides of the road; and
solar cells arranged on the top support, each of the solar cells having a light receiving surface that is tilted downward, toward a same side of the road at a substantially same angle, thereby facing an orientation where sunlight intensity is greater.

2. The solar energy utilization apparatus according to claim 1, wherein the solar cells are also installed on that side of the mounting frame where the sunlight intensity is greater, and the solar cells located at the top support and those located at the side of the mounting frame are arranged in an L shape.

3. The solar energy utilization apparatus according to claim 2, wherein slits are formed between the top support and that side of the mounting frame where the solar cells are installed, whereby allowing sunlight and wind to pass through.

4. The solar energy utilization apparatus according to claim 1, wherein the lateral mounting legs on the sides of the top support have different heights, whereby making the solar cells on the top support to be tilted.

5. The solar energy utilization apparatus according to claim 1, wherein a middle mounting leg is connected at a middle of the top support and configured to install on a middle position of the road.

6. The solar energy utilization apparatus according to claim 1, further comprising a transmission module and a wireless charging module, the transmission module being configured to transmit electric energy in the solar cells to the wireless charging module, and the wireless charging module being configured to wirelessly charge vehicles on the road.

7. The solar energy utilization apparatus according to claim 6, wherein the wireless charging module is arranged on the top support.

8. The solar energy utilization apparatus according to claim 6, wherein the wireless charging module is arranged on the road.

9. The solar energy utilization apparatus according to claim 1, further comprising a transmission module and a charging pile, the transmission module being configured to transmit electric energy in the solar cells to the charging pile, wherein the charging pile is configured to charge vehicles.

10. The solar energy utilization apparatus according to claim 1, further comprising an auxiliary mounting frame installed on a roadbed slope side where the sunlight intensity is greater, wherein the solar cells are also installed on the auxiliary mounting frame.

11. The solar energy utilization apparatus according to claim 1, wherein the solar cells are arranged into a solar cell array, each of the solar cells is supported by a respective rotatable supporting frame.
